(19) United States
(12) Patent Application Publication
(10) Pub. No.: US 2020/0262586 A1
(43) Pub. Date: Aug. 20, 2020

(54) METHOD FOR ASSEMBLING TWO COMPONENTS AND METHOD FOR ASSEMBLING TWO PORTIONS OF AN AIRCRAFT

(71) Applicant: Airbus Operations (S.A.S.), Toulouse (FR)

(72) Inventor: Eric Farre, Colomiers (FR)

(21) Appl. No.: 16/780,072

(22) Filed: Feb. 3, 2020

(30) Foreign Application Priority Data
Feb. 15, 2019 (FR) 1901538

(51) Int. Cl. B64F 5/10; B64C 1/06

(52) U.S. Cl. CPC B64F 5/10; B64C 1/069

(57) ABSTRACT

A method for assembling two components and method for assembling two portions of an aircraft. A method for assembling first and second components includes, prior to the setting in place of temporary linking elements in the first and second starter holes, producing the first starter holes in the first component, depositing a sealing mastic on at least one of the first and second contact faces of the first and second components, placing the first and second components against one another, and producing second starter holes in the second component using a drilling tool connected to a suction system and equipped with a drill bush including a first part that has an outside diameter less than or equal to that of the first starter holes and a first end bearing against the second contact face of the second component upon production of the second starter holes.

### CROSS-REFERENCE TO RELATED APPLICATION

This application claims priority to French patent application 19 01538 filed on Feb. 15, 2019, the entire disclosure of which is incorporated by reference herein.

### TECHNICAL FIELD

The present application relates to a method for assembling two components and also to a method for assembling two portions of an aircraft.

### BACKGROUND

According to an embodiment, an aircraft comprises a plurality of portions produced independently of one another, which are positioned end-to-end and assembled to one another using a plurality of final linking elements, such as rivets or bolts, for example, accommodated in final holes of given diameter.

According to a known operating method, the two portions to be assembled are preassembled then drilled in order to produce the starter holes, which have a diameter less than that of the final holes. Next, the two portions are detached from one another, then cleaned. The contact surfaces of each of the portions are coated with an air- and watertight mastic, then the two portions are reassembled. Temporary linking elements are set in place in the starter holes to hold the two portions upon production of the final holes and the fitting of the final linking elements between the temporary linking elements. Lastly, the temporary linking elements are removed, the starter holes redrilled with the diameter of the final holes and final linking elements are set in place in the final holes such as to replace the temporary linking elements.

This operating method is not entirely satisfactory because the preassembly, detachment and then reassembly operations tend to increase the duration of the assembly method.

### SUMMARY

The disclosure herein aims to remedy all or some of the prior-art drawbacks.

To that end, the subject of the disclosure herein is a method for assembling first and second components connected in an assembled state by a plurality of final linking elements, the first and second components having first and second contact faces facing one another in the assembled state and also final holes in which the final linking elements are accommodated.

According to the disclosure herein, the assembly method comprises the steps of:
producing first starter holes in the first component,
depositing a sealing mastic on at least one of the first and second contact faces,
placing the first and second components against one another,
producing second starter holes in the second component using a drilling tool connected to a suction system and equipped with a drill bush comprising a first part that has an outside diameter less than or equal to that of the first starter holes and a first end bearing against the second contact face of the second component upon production of the second starter holes,
setting in place temporary linking elements positioned in the first and second starter holes,
producing final holes between the temporary linking elements and setting in place the definitive linking elements in the final holes,
removing the temporary linking elements, drilling the final holes in the location of the first and second starter holes and setting in place the definitive linking elements in the final holes.

The presence of sealing mastic between the first and second contact faces and the use of a drill bush bearing against the second contact face of the second component makes it possible to obtain a seal between the drill bush and the second component upon drilling the second starter holes and suction, via the suction system, of all the waste produced upon drilling. Thus, there is no longer a need to detach the first and second components from one another in order to clean the first and second contact faces, then to reassemble them in order to set in place the final linking elements.

According to a further feature, the outside diameter of the first part of the drill bush is equal to that of the first starter holes such that the first part of the drill bush is inserted into one of the first starter holes.

According to a further feature, the first part of the drill bush has a thickness of the order of 0.6 mm.

According to a further feature, each temporary linking element is a self-tapping screw comprising a threaded cylindrical body and also a head, the threaded cylindrical body having a diameter less than that of the first starter holes and being configured such as to obtain screwing of the self-tapping screw in one of the second starter holes.

A further subject of the disclosure herein is a method for assembling two portions of an aircraft by implementing the assembly method according to one of the preceding features.

### BRIEF DESCRIPTION OF THE DRAWINGS

Further features and advantages will become apparent from the following description of the disclosure herein, which is given solely by way of example with regard to the appended, example figures, in which:

FIG. 1 is a lateral view of an aircraft;

FIG. 2 is a lateral view of two aircraft portions prior to being assembled, which illustrates an embodiment of the disclosure herein;

FIG. 3 is a cross section through two components to be assembled, showing a step of producing starter holes in one of the two components to be assembled, which illustrates an embodiment of the disclosure herein;

FIG. 4 is a longitudinal section through the two components visible in FIG. 3, after a coating step;

FIG. is a longitudinal section through a drilling tool, which illustrates an embodiment of the disclosure herein prior to a drilling step;

FIG. 6 is a longitudinal section through the drilling tool visible in FIG. 5, after the drilling step;

FIG. 7 is a cross section through two components to be assembled and a temporary linking element, which illustrates an embodiment of the disclosure herein at the start of screwing;

FIG. 8 is a cross section through the two components to be assembled and the temporary linking element visible in FIG. 7, at the end of screwing;

FIG. 9 is a cross section through two components to be assembled connected by a temporary linking element, which illustrates a step in producing a final hole;

FIG. 10 is a cross section through the two components visible in FIG. 9, which illustrates a step of setting in place a definitive linking element;

FIG. 11 is a cross section through the two components visible in FIG. 9, which illustrates a step of producing a final hole at the location of the temporary linking element; and

FIG. 12 is a cross section through the two components visible in FIG. 9, which illustrates a step of setting in place a definitive linking element at the location of the temporary linking element.

### DETAILED DESCRIPTION

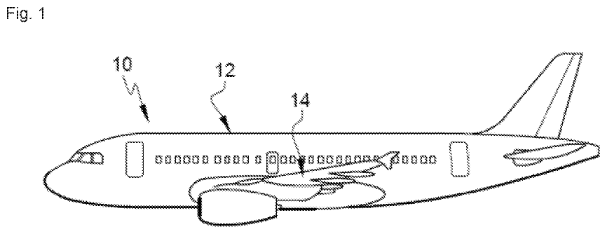

FIG. 1 shows an aircraft 10 that comprises a fuselage 12 and also wings 14 positioned on either side of the fuselage 12.

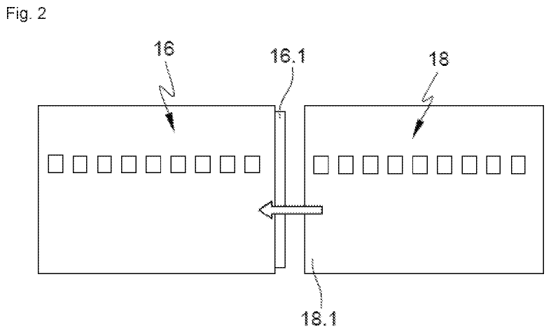

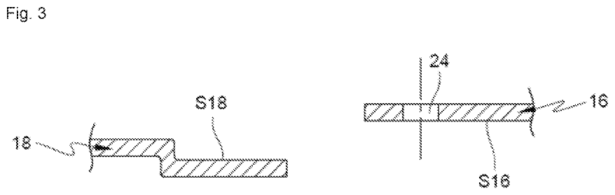

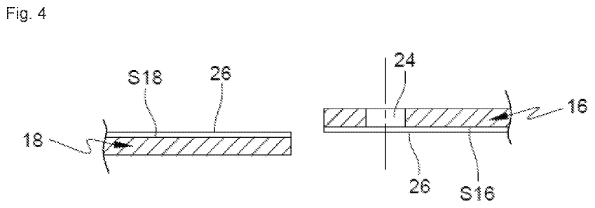

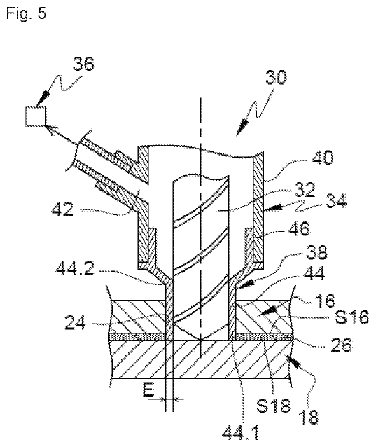

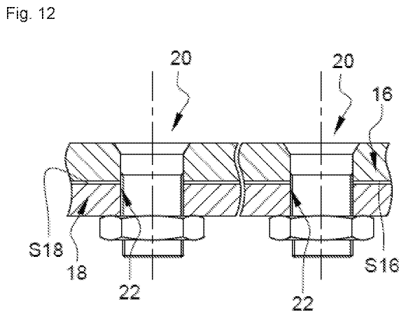

According to an embodiment that can be seen in FIG. 2, the fuselage 12 comprises a plurality of portions 16, 18 produced independently of one another, positioned end-to-end and assembled to one another using a plurality of final linking elements 20 (visible in FIG. 12), such as rivets or bolts, for example, accommodated in final holes 22 of given diameter.

According to one configuration, a first portion 16 has a first circular edge 16.1 fitted in a second circular edge 18.1 of a second portion 18. The first circular edge 16.1 is connected to the second circular edge 18.1 via at least one series of final linking elements 20 positioned in at least one transverse plane. The disclosure herein is not limited to the assembly of two portions of the fuselage. It may apply to other portions of the aircraft such as, for example, the portions of a wing of an aircraft.

The first and second portions 16, 18 are not further described as they may be identical to those of the prior art. Similarly, the disclosure herein is not limited to the assembly of two portions 16, 18. It may be used more broadly to assemble at least two components 16, 18 using a plurality of final linking elements 20. When the first and second components 16 and 18 are in the assembled state, the first component 16 comprises a first contact face S16 facing the second component 18 and the latter comprises a second contact face S18 facing the first component 16.

The assembly method comprises a step of producing first starter holes 24 in the first component 16. Each first starter hole 24 has a diameter less than or equal to that of a final hole 22. Each first starter hole 24 is positioned at the location of a final hole 22.

According to an operating method, the first starter holes 24 are produced by drilling. Of course, the disclosure herein is not limited to this embodiment. Thus, the first starter holes 24 could be produced upon production of the first component 16.

The assembly method comprises a step of depositing a sealing mastic 26 on at least one of the first and second contact faces S16, S18. According to an embodiment, the first and second contact faces S16, S18 are coated with sealing mastic 26. The sealing mastic 26 and the operating method of depositing the sealing mastic 26 are not further described as they may be identical to those of the prior art.

The assembly method comprises a step of placing the first and second components 16, 18 against one another such that the sealing mastic 26 is intercalated between the first and second contact faces S16, S18, as illustrated in FIG. 5. At the end of this step, the first and second components 16 and 18 are positioned approximately as in the assembled state.

The assembly method comprises a step of producing second starter holes 28 in the second component 18, which are coaxial with the first starter holes 24 present in the first component 16. The second starter holes 28 have a diameter less than that of the first starter holes 24.

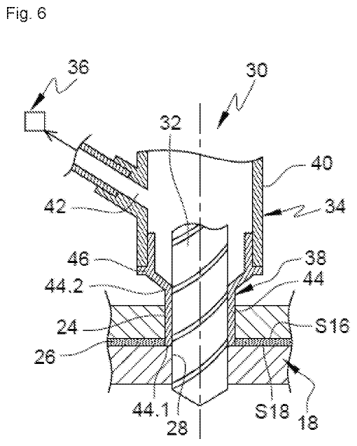

According to an embodiment that can be seen in FIGS. 5 and 6, each second starter hole 28 is produced by drilling, using a drilling tool 30 comprising a drill 32 and also a chuck 34 in which the drill 32 is positioned, the chuck 34 being connected to a suction system 36 and equipped with a drill bush 38.

The chuck 32 comprises a cylindrical body 40 having a branch 42 connected to the suction system 36. The drill 32 has a diameter equal to the diameter of the second starter holes 28.

The drill bush 38 comprises a first, tubular part 44 that extends between first and second ends 44.1, 44.2 and has an inside diameter approximately equal to that of the drill 32 and an outside diameter less than or equal to the diameter of the first starter holes 24. The drill bush 38 also comprises a second part 46 configured such as to connect the second end 44.2 of the first part 44 and the chuck 34.

According to an embodiment, the first part 44 has a thickness E of the order of 0.6 mm.

In operation, when the outside diameter of the first part 44 of the drill bush 38 is less than or equal to the diameter of the first starter holes 24, the first end 44.1 of the first part bears against the contact face S18 of the second component 18. When the outside diameter of the first part 44 of the drill bush 38 is equal to the diameter of the first starter holes 24, the first part 44 of the drill bush 38 is fitted into one of the first starter holes 24 and the drill 32 is coaxial with the first starter hole 24.

The presence of the sealing mastic 26 between the first and second contact faces S16 and S18 makes it possible to obtain a seal between the drill bush 38 and the second component 18 upon drilling the second starter holes 28. As a result, all the waste produced upon drilling the second starter holes 28 is aspirated by the suction system 36. According to the disclosure herein, it is no longer necessary to detach the first and second components 16 and 18 in order to clean the interface between the first and second contact faces S16, S18, which makes it possible to shorten the duration of the assembly method.

The assembly method comprises a step of setting in place temporary linking elements 48 in the first and second starter holes 24, 28.

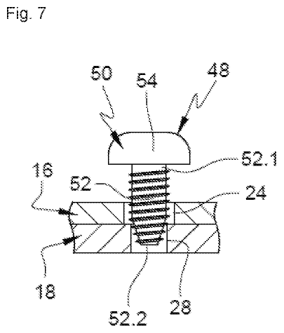

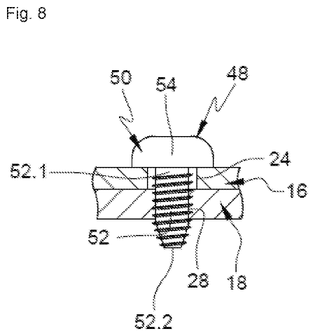

According to an embodiment that can be seen in FIGS. 7 and 8, each temporary linking element 48 is a self-tapping screw 50. Each of them comprises a threaded cylindrical body 52 and a head 54 connected to a first end 52.1 of the threaded cylindrical body 52. According to one configuration, the threaded cylindrical body 52 has a diameter less than that of the first starter holes 24, the diameter of the threaded cylindrical body 52 being configured such as to obtain screwing of the self-tapping screw 50 in the second starter hole 28.

At the start of the setting-in-place step, each self-tapping screw 50 is approximately centered in a starter hole 24, the second end 52.2 of the cylindrical body 52 being positioned in the second starter hole 28. Next, the self-tapping screw 50 is screwed until the head 54 bears against the first component 16, as illustrated in FIG. 8.

The self-tapping screws 50 each cost less than the temporary linking elements 48 of the prior art and may be set in place without a specific tool.

The number of temporary linking elements 48 and their arrangement are determined such that, after all the temporary linking elements 48 have been set in place, the first and second components 16, 18 are sufficiently held to allow the subsequent steps of drilling the final holes 22 and of fitting the definitive linking elements 20.

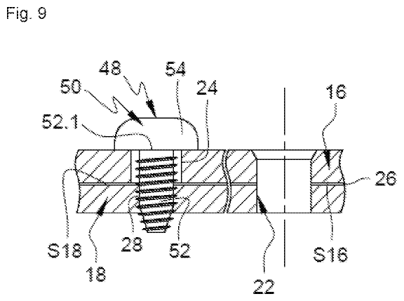

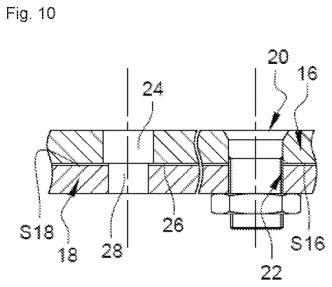

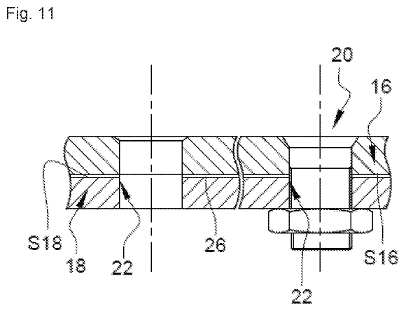

The assembly method then comprises a step of producing the final holes 22 between the temporary linking elements 48, as illustrated in FIG. 9, and also a step of setting the definitive linking elements 20 in place in the final holes 22, as illustrated in FIG. 11.

Finally, the assembly method comprises the steps of removing the temporary linking elements 48, as illustrated in FIG. 11, drilling the final holes 22 in the location of the first and second starter holes 24, 28, as illustrated in FIG. 12, and setting the definitive linking elements 20 in place in the final holes 22, as illustrated in FIG. 13.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assembling first and second components connected in an assembled state by a plurality of final linking elements, the first and second components having first and second contact faces facing one another in the assembled state and also final holes in which the final linking elements are accommodated, the method for assembling comprising:
producing first starter holes in the first component;
depositing a sealing mastic on at least one of the first and second contact faces;
placing the first and second components against one another;
producing second starter holes in the second component using a drilling tool connected to a suction system and equipped with a drill bush comprising a first part that has an outside diameter less than or equal to a diameter of the first starter holes and a first end bearing against the second contact face of the second component upon production of the second starter holes;
setting in place temporary linking elements positioned in the first and second starter holes;
producing final holes between the temporary linking elements and setting in place definitive linking elements in the final holes; and
removing the temporary linking elements, drilling the final holes in a location of the first and second starter holes and setting in place the definitive linking elements in the final holes.

2. The method for assembling according to claim 1, wherein the outside diameter of the first part of the drill bush is equal to a diameter of the first starter holes such that the first part of the drill bush is inserted into one of the first starter holes.

3. The method for assembling according to claim 1, wherein the first part of the drill bush has a thickness of 0.6 mm.

4. The method for assembling according to claim 1, wherein each temporary linking element is a self-tapping screw comprising a threaded cylindrical body and also a head, the threaded cylindrical body having a diameter less than a diameter of the first starter holes and being configured to obtain screwing of the self-tapping screw in one of the second starter holes.

5. A method for assembling two portions of an aircraft, the method comprising:
a method for assembling first and second components connected in an assembled state by a plurality of final linking elements, the first and second components having first and second contact faces facing one another in the assembled state and also final holes in which the final linking elements are accommodated, the method for assembling comprising:
producing first starter holes in the first component;
depositing a sealing mastic on at least one of the first and second contact faces;
placing the first and second components against one another;
producing second starter holes in the second component using a drilling tool connected to a suction system and equipped with a drill bush comprising a first part that has an outside diameter less than or equal to a diameter of the first starter holes and a first end bearing against the second contact face of the second component upon production of the second starter holes;
setting in place temporary linking elements positioned in the first and second starter holes;
producing final holes between the temporary linking elements and setting in place definitive linking elements in the final holes; and
removing the temporary linking elements, drilling the final holes in a location of the first and second starter holes and setting in place the definitive linking elements in the final holes.
